(19) United States
(12) Patent Application Publication
(10) Pub. No.: US 2025/0251259 A1
(43) Pub. Date: Aug. 7, 2025

(54) MODULARITY CONDITION MONITORING SENSOR

(71) Applicant: Aktiebolaget SKF, Göteborg (SE)

(72) Inventors: Vincent SAUSSET, Azay-le-Rideau (FR); Arnaud PINON, Azay sur Cher (FR)

(21) Appl. No.: 19/032,865

(22) Filed: Jan. 21, 2025

(30) Foreign Application Priority Data
Feb. 2, 2024 (DE) 102024200971.7

(51) Int. Cl. G01D 11/24

(52) U.S. Cl. CPC G01D 11/245

(57) ABSTRACT

A sensor (51) includes a housing (52), an electrical power supply device (64), and at least one electronic card (65, 66, 67) housed inside the housing (52). The electrical power supply device (64) and said at least one electronic card (65, 66, 67) are removable from the housing (52).

### CROSS-REFERENCE TO RELATED APPLICATION

This application claims priority to German Application No. 102024200971.7, filed Feb. 2, 2024, the entirety of which is hereby incorporated by reference.

### FIELD

The present disclosure relates to the field of sensors, and particularly concerns those used on rotating equipment.

### BACKGROUND

Such rotating equipment may be used for example in heavy industry applications, such as food and beverage, pulp and paper, moving equipment, tunnel boring, mining extraction, wind turbines.

Whatever its area of use, monitoring of a rotating equipment is needed. Various physical characteristics, such as temperatures, vibrations, loads, stresses, speeds or other, must be monitored and analysed to control the condition of the equipment. To check the different characteristics, appropriate sensors are used.

For example, a temperature sensor can be used to check the heating level of a ball bearing. A speed sensor will be used to measure the rotational speed of a wheel. A vibration sensor can be used to control the balancing of a wind turbine propeller.

There are in fact a very large number of sensors, with different shapes, different materials, different means of securing to a support, different means of transmitting the measured values. Accordingly, using of different sensors for different measurements is very widespread, and often allows correct monitoring of the state of an equipment.

For each application, a specific sensor is placed on the equipment in the appropriate location. The information provided by a sensor is recovered by wire or non-wire, depending on the configuration. The information can be viewed or used by a suitable monitoring system. For example, the information can be processed by a computing device to generate alerts.

Sensors generally work well and give satisfaction. However, the implementation of sensors has some drawbacks.

It is sometimes necessary to replace a sensor, either identically, or with an equivalent model, or even with an improved model. This may be due to a breakdown. This need may also be due to a possibility of improvement, for example increasing solidity, sensitivity, precision, or other. This need can still respond to an evolution of technology, such as a change in mode of communication with an environment.

Changing a sensor is generally quite complicated, quite long, and expensive, particularly in the case of sensors installed by gluing.

Moreover, maintenance often requires a large stock of sensors of all kinds, which may be intended for machines with different functions, or of different brands. Managing a large stock is complex and expensive.

The present disclosure wishes, among other things, to overcome these drawbacks. The present disclosure seeks to improve the implementation and maintenance of sensors, in particular by making them simpler, faster, and less expensive. The present disclosure also seeks to reduce the number of sensors necessary for the maintenance of a fleet of machines.

### SUMMARY

The present disclosure relates to a sensor comprising a housing, and an electrical power supply device and at least one electronic card housed inside the housing. The electrical power supply device and said at least one electronic card are removable from the housing.

Each card can perform one or more functions, and the structure of the sensor allows renewal of each removable card. Accordingly, it is possible to assign one or a few desired functions to the sensor. This also allows the replacement of a defective card. The sensor can therefore be configured according to a specific need; its role is optimized. It is easier to meet specifications, to carry out a total or partial replacement of components. Among the advantages that result from it, implementation and maintenance are simpler, faster, and less expensive. With a reduced number of cards, the sensor addresses a significant number of issues. And a small number of components is enough.

At least one electronic card is intended to collect data. This allows customization or maintenance of the specific function of data collection.

At least one electronic card is intended to process data. This allows customization or maintenance of the specific function of data processing.

At least one electronic card is intended to transmit data. This allows customization or maintenance of the specific function of data transmission.

One or many cards is or respectively are housed in a card holder which itself is or themselves are housed in the housing in a removable manner. This protects the card and makes it easier to handle.

A basket, removably housed in the housing, contains the electrical power supply device and one or many cards. This makes configuring the sensor easier. The basket allows quick and direct access to each card.

The electrical power supply device is a battery. This device structure is reliable and simple to implement.

The sensor structure is comprised of several parts assembled in a reversible manner. The sensor can be disassembled and reassembled. The modularity of the sensor makes it possible to configure or modify its structure, in whole or in part. The sensor can therefore be configured according to a specific shape.

The housing comprises a base to which a body is secured, and a cover secured to the body. This allows configuring all sides of the sensor.

The present disclosure is also directed to a method of implementing a sensor comprising a housing for housing an electrical power supply device and at least one electronic card, the method comprising the following steps: opening the housing, placing or replacing a removable electrical power supply device and/or at least one removable electronic card, closing the housing.

### BRIEF DESCRIPTION OF THE DRAWINGS

The present disclosure and its advantages will be better understood by studying the detailed description of specific embodiments given by way of non-limiting examples and illustrated by the appended drawings on which:

FIG. 1 is a global perspective view of a sensor, according to a first example of the present disclosure,

FIG. 2 is a sectional view of the sensor of FIG. 1,

FIG. 3 is an exploded longitudinal section view of the sensor of FIGS. 1 and 2,

FIG. 4 is a description of the assembly of the sensor of FIGS. 1, 2 and 3,

FIG. 5 is an exploded longitudinal section view of a sensor according to a second example of the present disclosure,

FIG. 6 is an exploded perspective view of a sub-assembly of the sensor of FIG. 5.

### DETAILED DESCRIPTION

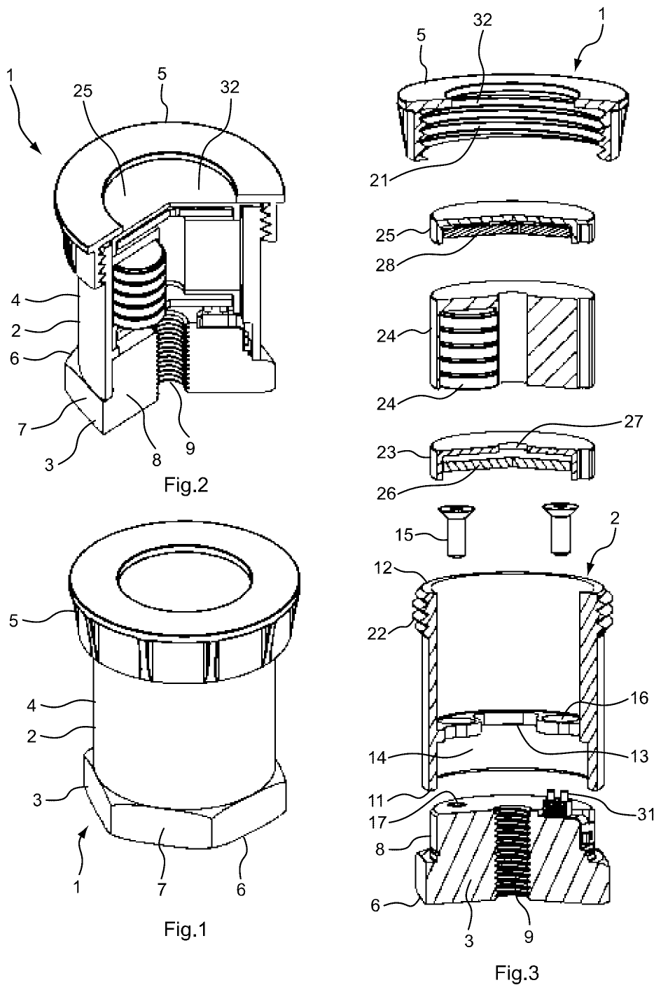

A sensor 1 according to the first example, as illustrated in FIG. 1, includes a housing 2 which itself includes a base 3, a body 4 and a cover 5, the body 4 being located between the base 3 and the cover 5. The different components of the sensor 1 are detailed in FIGS. 2 and 3.

In a non-limiting manner, the base 3 is a guide nut. The base 3 comprises a portion 6 provided with sides 7, and a circular guide portion 8. There are six sides 7, but another quantity could be suitable. The base 3 is crossed over its entire length by a through threaded hole 9, but alternatively a blind threaded hole could be provided which opens outside the sensor 1. By means of the hole 9, the base 3 of the sensor 1 can be installed on a component by screwing. Hole 9 is a means of mechanical connection.

The body 4 extends longitudinally between a first connecting end 11, designed to be secured to the base 3, and a second connecting end 12, designed to be secured to the cover 5. The body 4 has the general shape of a cylinder. The interior of the body 4 has a shoulder 13, the distance between it 13 and the first end 11 delimiting a nesting part 14 to be placed on the circular guide portion 8 of the base 3.

The restraint of the body 4 on the base 3 is ensured by a means of securing made by a screw-nut connection. For example, screws 15 cross through holes 16 in the shoulder 13 to then screw into threaded holes 17 in the base 3. Consequently the body 4 is retained on the base 3 in reversible manner. The connection between the body 4 and the base 3 is removable. The screws 15 and the threaded holes 17 are part of the removable mechanical connection between the base 3 and the body 4.

The restraint of the cover 5 on the body 4 is ensured by a means of securing made by a screw-nut connection. For example, the cover 5 is a circular part which has an internal thread 21, and the second connecting end 12 of the body 4 has an external thread 22. Consequently, the cover 5 is retained on the body 4 in reversible manner. The connection between the cover 5 and the body 4 is removable. The internal thread 21 and the external thread 22 are part of the removable mechanical connection between the cover 5 and the body 4.

Because the base 3, the body 4 and the cover 5 are removably joined, the sensor 1 has a modular housing 2. In other words, the sensor structure is comprised of several parts 3, 4, 5 assembled in a reversible manner. It is therefore possible to replace only one or only two parts of the housing 2. This allows, for example, to modify the interior volume of the housing 2, which also is the interior volume of the sensor 1. Simply replace the body 4 with another, shorter or longer.

The housing 2 houses several components. In a non-limiting manner, a first removable electronic card holder 23, a removable electrical power supply device 24, and a second removable electronic card holder 25 are housed in the housing 2.

The first removable electronic card holder 23 has the shape of a cover, in which an electronic card 26 is inserted. In a non-limiting manner, the card 26 is retained in the card holder 23 by friction. The shape of the card 26 can be circular, and the mechanical manufacturing tolerance allows it to be wedged into the card holder 23.

It is possible to separate the card 26 from the card holder 23 by pushing it in the opposite direction of installation. For this, an opening 27 is made in the card holder 23. Just push with a suitable tool to pop out the card 26.

It is also possible to remove the card holder 23 from the housing 2 with a suitable tool, one end of which has a hook shape or an equivalent shape. Simply insert the hook into the opening 27, then pull.

In the same spirit, the second removable electronic card holder 25 has the shape of a cover, in which an electronic card 28 is inserted. In a non-limiting manner, the card 28 is retained in the card holder 25 by friction. The shape of the card 28 can be circular, and the mechanical manufacturing tolerance allows it to be wedged into the card holder 25.

It is possible to separate the card 28 from the card holder 25 by pulling it in the opposite direction of installation. Just pull with a suitable tool to pop out the card 28.

The removable electrical power supply device 24 is inserted inside the housing 2, between the two card holders 23, 25. In a non-limiting manner, the device 24 includes a set of electric batteries 29. Alternatively, the device 24 could include a single battery 29.

In addition, an electrical connector 31 is provided inside the housing 2. This connector 31 can for example be used to activate electrical wiring, not shown, internal to the sensor 1.

When all components are in place in the housing 2, as shown in FIG. 2, the sensor is ready to operate. It is possible to visually ensure the presence of the components: the cover 5 has a through hole 32 which serves as a window.

Each electronic card 26, 28 can perform various functions, such as measuring temperature, vibrations, or other values, or communicate with peripherals for example in Wi-Fi mode, in Bluetooth mode, in RFID mode, or other. That is why the sensor 1 can transmit measured values to receivers.

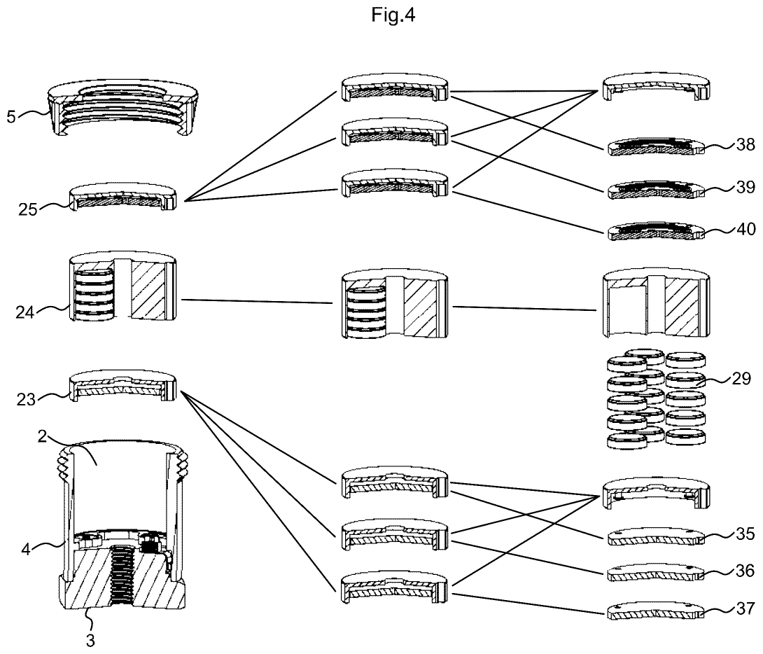

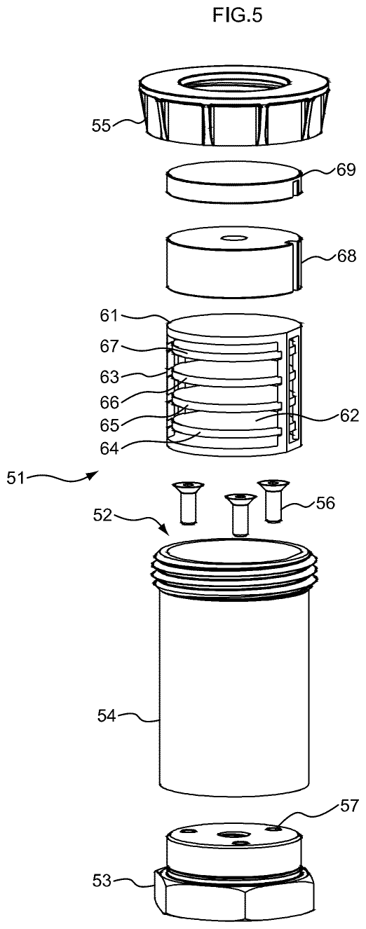

As shown in FIG. 4, it is possible to configure the sensor 1 by selecting cards that have specific characteristics.

An electronic card designed to be inserted into the first card holder 23 is chosen. For example, for transmitting data, it can be a card for Wi-Fi 35, an electronic card for NFC 36, an electronic card for Bluetooth 37, or else. Otherwise, a card can perform one or more functions such as collecting data or processing data. In the same spirit, an electronic card designed to be inserted into the second card holder 25 is chosen. For example, it can be a Wi-Fi card 38, an NFC card 39, a Bluetooth card 40. Again, a card can perform one or more other functions such as collecting data or processing data. The cards 35, 36, 37 for the first holder 23 and the cards 38, 39, 40 for the second holder 25 are respectively compatible. Then each card holder 23, 25 containing a card, as well as the electrical power supply device 24, are placed in the housing 2, making the sensor 1 ready for use.

A sensor 51 according to the second example, as illustrated in FIG. 5, includes a housing 52 which itself includes a base 53, a body 54 and a cover 55, the body 54 being located between the base 53 and the cover 55. As for the first example, the base 53, the body 54 and the cover 55 according to the second example are removably joined, the sensor 51 having a modular housing 52.

The restraint of the body 54 on the base 53 is ensured by a means of securing made by a screw-nut connection. For example, screws 56 cross through holes not shown inside the body 54 to then screw into threaded holes 57 in the base 53. Consequently, the body 54 is retained on the base 53 in reversible manner. The connection between the body 54 and the base 53 is removable.

The sensor 51 comprises a basket 61, removably housed in the housing 52. The basket 61 is for example made from a synthetic material such as plastic, or any equivalent material.

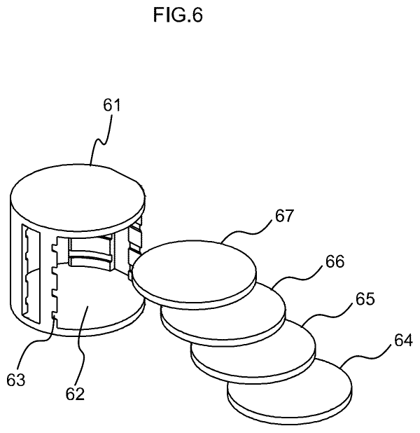

As it appears both in FIG. 5 and FIG. 6, the basket 61 is for example a hollow cylinder, with a peripheral opening 62 and peripheral circular grooves 63 in its interior. It is possible to place one or more electrical power supply devices 64, as well as one or more cards 65, 66, 67, inside the basket 61. Each electrical power supply device 64 and each card 65, 66, 67 are reversibly clipped into the basket 61.

In a non-limiting manner, the basket 61 accommodates four components, namely one electrical power supply device 64, one card 65 intended to collect data, one card 66 intended to process data, and one card 67 intended to transmit data. The electrical power supply device 64 may be a battery. In a non-limiting manner, all components have the same diameter and the same thickness. This facilitates placement in the basket, placement which can be done in a specific order, or in any order, depending on the configurations.

In addition, the sensor 51 includes a shock absorber 68 housed between the basket 61 and the cover 55, as well as a receiving end 69 for the shock absorber 68 on the cover side. The shock absorber 68 may be made from any suitable material, such as rubber, synthetic foam, or other. The shock absorber 68 can be sized to be slightly compressed, and thus immobilize the basket 61 in the housing 52. This improves the shock resistance of the sensor 51.

The present disclosure is not limited to the examples described and includes all the equivalents which fall within the scope of the claims which follow.

All suitable materials can be used to make the different parts of the housing 2, 52. A circular section for the sensor is not the only possible one. Other shapes could be suitable, such as a square, a rectangle, or other. Different electronic cards can be selected for maintenance or configuration of the sensor 1, 51. In some cases a single card may be provided, in other cases more than two cards may be provided.

What is claimed is:

1. A sensor comprising:
a housing;
an electrical power supply device housed inside the housing, the electrical power supply device being removable from the housing; and
at least one electronic card housed inside the housing, said at least one electronic card being removable from the housing.

2. The sensor according to claim 1, wherein said at least one electronic card is configured to collect data.

3. The sensor according to claim 1, wherein said at least one electronic card is configured to process data.

4. The sensor according to claim 1, wherein said at least one electronic card is configured to transmit data.

5. The sensor according to claim 1, wherein one or many cards is or respectively are housed in a card holder which itself is or themselves are housed in the housing in a removable manner.

6. The sensor according to claim 1, further comprising a basket removably housed in the housing, the basket containing the electrical power supply device and one or many cards.

7. The sensor according to claim 1, wherein the electrical power supply device is a battery.

8. The sensor according to claim 1, wherein the sensor structure is comprised of several parts assembled in a reversible manner.

9. The sensor according to claim 8, wherein the housing comprises a base, a body secured to the base, and a cover secured to the body.

10. The sensor according to claim 2, wherein said at least one electronic card is configured to process data.

11. The sensor according to claim 10, wherein said at least one electronic card is configured to transmit data.

12. The sensor according to claims 11, wherein one or many cards is or respectively are housed in a card holder which itself is or themselves are housed in the housing in a removable manner.

13. The sensor according to claim 11, further comprising a basket removably housed in the housing, the basket containing the electrical power supply device and one or many cards.

14. The sensor according to claim 13, wherein the electrical power supply device is a battery.

15. The sensor according to claim 14, wherein the sensor structure is comprised of several parts assembled in a reversible manner.

16. The sensor according to claim 15, wherein the housing comprises a base, a body secured to the base, and a cover secured to the body.

17. A method of implementing a sensor, the method comprising:
opening a housing of the sensor;
placing or replacing a removable electrical power supply device housed in the housing of the sensor and/or at least one removable electronic card housed in the housing of the sensor; and
closing the housing.
